(19) United States
(12) Patent Application Publication
(10) Pub. No.: US 2019/0337205 A1
(43) Pub. Date: Nov. 7, 2019

(54) INTERCHANGEABLE MOLD FOR CREATION OF INJECTION MOLDED COMPONENTS

(71) Applicant: Vision Service Plan, Rancho Cordova, CA (US)

(72) Inventors: Dhruvay Jain, Jersey City, NJ (US); Carl Allen, Brooklyn, NY (US); Adam Oranchak, Queens, NY (US); Andrew Clemenson, Edgewater, NJ (US)

(21) Appl. No.: 16/402,706

(22) Filed: May 3, 2019

Related U.S. Application Data
(60) Provisional application No. 62/667,330, filed on May 4, 2018.

(51) Int. Cl. B29C 45/26; B33Y 80/00; B29C 33/38

(52) U.S. Cl. CPC B29C 45/2673; B33Y 10/00; B29C 33/3842; B33Y 80/00

(57) ABSTRACT

An interchangeable mold for use in the manufacture of injection molded components is disclosed. An interchangeable mold can have a component mold made of one material (e.g., metal) and a base mold made of another material (e.g., polymer). Each of the base mold and the component mold can be manufactured using additive or subtractive manufacturing processes. The component mold can be attached and detached from the base mold to permit the forming of different components using the same base mold.

### CROSS-REFERENCE TO RELATED APPLICATIONS

This application claims the benefit of U.S. Provisional Patent Application No. 62/667,330, filed on May 4, 2018, and entitled “INTERCHANGEABLE MOLD FOR CREATION OF INJECTION MOLDED COMPONENTS,” the entire disclosure of which is hereby incorporated by reference herein.

### BACKGROUND

Traditional methods of making molds for injection molded components use subtractive manufacturing processes that remove material from a piece of raw material to create a mold. Examples of subtractive manufacturing processes include computer numerical control (CNC) machining, metal cutting, and surfacing. The raw material used in many such processes is metal, typically in the form of a metal block. Traditional subtractive manufacturing processes can be costly, time consuming, and often present operational and/or logistical challenges. Specifically, traditional subtractive manufacturing processes require purchasing excessive raw material since material is removed to create the desired product. The quantity of product removed during traditional subtractive manufacturing processes creates excessive material waste. Product molds created through subtractive manufacturing of large blocks of raw material can be large and heavy, resulting in extended die-changeover times on production lines and larger inventory space requirements when managing multiple product profiles.

Advancements in three-dimensional (3D) printing technologies have increased the capabilities of additive manufacturing processes, where layers of material are built up to create an object. Rapid prototyping methods can now be used for making fully polymer 3D printed molds. Additive manufacturing processes additionally allows for making fully metal-based 3D printed molds. However, manufacture of these types of molds includes limitations such as shorter tool life spans and higher costs of production.

There is a need for a systems and processes for manufacturing molds for injection molded components that are more cost effective than current methods while also increasing tool life and shortening manufacturing times.

### SUMMARY

Challenges associated with traditional subtractive manufacturing processes and with traditional additive manufacturing processes are overcome utilizing the various embodiments disclosed herein. Specifically, an interchangeable mold for use in the manufacture of injection molded components utilizes additive, subtractive, and/or a combination of additive and subtractive manufacturing processes to create a base mold and a removable and replaceable component mold that advantageously minimizes material costs, minimizes production costs, reduces die-changeover times, and decreases storage space.

According to various embodiments, an interchangeable mold may have a component mold that includes a top portion and a bottom portion, where the top portion of the component mold and the bottom portion of the component mold define a component profile. An interchangeable mold may also have a base mold that includes a top portion and a bottom portion, where the top portion of the base mold accommodates a profile of the top portion of the component mold and the bottom portion of the base mold accommodates a profile of the bottom portion of the component mold. A bottom portion of a component mold may be configured to be detachably affixed to a bottom portion of a base mold and a top portion of a component mold may be configured to be detachably affixed to a top portion of a base mold.

A method of manufacturing an interchangeable mold is disclosed, where a top portion of a component mold and a bottom portion of the component mold may be manufactured such that the top portion of the component mold and the bottom portion of the component mold define a profile of a component. A top portion of a base mold and a bottom portion of a base mold may be manufactured such that the top portion of the base mold accommodates a profile of a top portion of a component mold and the bottom portion of the base mold accommodates a profile of a bottom portion of a component mold. A bottom portion of a component mold may be manufactured to be detachably affixed to a bottom portion of a base mold and a top portion of a component mold may be manufactured to be detachably affixed to a top portion of a base mold.

A method of manufacturing an injection molded component is disclosed, where a top portion of a component mold may be detachably affixed to a top portion of a base mold, the top portion of the component mold defining a top portion of a profile of the injection molded component and the top portion of the base mold accommodating the top portion of the component mold. A bottom portion of the component mold may be detachably affixed to a bottom portion of the base mold, the bottom portion of the component mold defining a bottom portion of the profile of the injection molded component and the bottom portion of the base mold accommodating the bottom portion of the component mold. An injection mold may be assembled from a top portion of a component mold, a top portion of a base mold, a bottom portion of a component mold, and a bottom portion of a base mold. Components may be manufactured by injecting material into the injection mold to form the injection molded component.

### BRIEF DESCRIPTION OF THE DRAWINGS

Various embodiments of the invention will be described below. In the course of the description, reference will be made to the accompanying drawings, which are not necessarily drawn to scale, and wherein:

FIG. 1 is an exploded view of an interchangeable mold having a base mold and a component mold according to various embodiments described below.

FIG. 2 is an exploded view of an alternative interchangeable mold having a base mold and a component mold according to various embodiments described below.

FIG. 3 is an exploded view of an interchangeable mold having a base mold with a base mold profile and a component mold with a component profile that varies from the base mold profile according to various embodiments described below.

FIG. 4 is a flowchart showing an example of a process of manufacturing an interchangeable mold according to various embodiments.

FIG. 5 is a flowchart showing an example of a process of manufacturing using an interchangeable mold according to various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Traditionally, to create molds for use in an injection molding process, subtractive manufacturing processes are often used, which include various limitations. For example, CNC equipment may be used to machine a block of material by grinding or cutting away material from the block. Material may be removed from the block in a pre-programmed manner, resulting in the creation of a mold having a profile of the component that will be manufactured using injection molding techniques. Molds may be manufactured from various types of material, including polymers and metals. Machining and other subtractive mold manufacturing processes can be cost and time intensive because often large quantities of mold material must be purchased and stored. Many metals used for molds are particularly costly to obtain and manufacture. Moreover, subtractive mold manufacturing processes can create excessive waste as costly material is removed from the blocks to create the molds. When numerous products or components are manufactured using molds, a separate mold may be required for each component profile being produced, necessitating the use of large inventory storage spaces to store the various molds. Having numerous large molds that must be interchanged in a production line as manufacturing transitions from one component to another requires costly change-over times.

Additive manufacturing processes, such as 3D printing, can also be used to create molds for use in an injection molding process. Such processes may generate less waste than subtractive manufacturing processes, but may include limitations such as shorter tool life spans and higher costs of production. While various embodiments may be discussed herein with respect to additive manufacturing processes, it should be appreciated that the various embodiments described herein are not limited to additive manufacturing processes. Rather, subtractive manufacturing processes, or a combination of additive and subtractive techniques, may be used without departing from the scope of this disclosure. According to various embodiments, the molds and corresponding components described herein may be made from additive manufacturing techniques performed along with subtractive manufacturing techniques to create the desired result in a cost effective and efficient manner, providing significant advantages over traditional subtractive manufacturing techniques and over traditional additive manufacturing techniques. The various techniques described herein will be referred to as additive-subtractive manufacturing processes. Throughout this disclosure, “additive and/or subtractive” manufacturing processes or techniques may include additive, subtractive, or additive-subtractive manufacturing processes or techniques.

3D printing can be performed using polymers and metals. However, polymer-based molds may not be able to be used to manufacture large quantities of molded components due to the degradation of polymers during mass production processes. Moreover, many commonly used and cost-effective polymers have relatively low melting points and therefore may not be suitable for the production of components formed from certain materials. For example, a polymer-based mold having a melting point that is lower than nylon would not be viable for the creation of a nylon component since the mold would melt when the melted nylon is injected into such a mold. Metal molds with higher melting points than the material from which a component is being molded may be used, but creating metal molds (using subtractive or additive manufacturing processes) may be costly.

Utilizing the concepts and techniques described herein, the limitations of traditional molds are overcome using molds created to take advantage of the cost-effectiveness of additive mold manufacturing processes and the durability of molds created using subtractive mold manufacturing processes. In an embodiment, a base mold may be created using additive and/or subtractive manufacturing techniques, for example, using a polymer material. A component mold formed from a metal that provides a long-lasting and heat tolerant interface with the component being made within the mold may be used in conjunction with the base mold. Such a metal component mold may be manufactured using subtractive and/or additive mold manufacturing processes, but because the metal component mold may use much less material than an entire metal mold, the use of the combination metal component mold and polymer base mold may greatly reduce the costs of mold manufacture. Moreover, swapping component molds when needed, as opposed to swapping an entire traditional mold, may reduce down time incurred when switching production from one item to another.

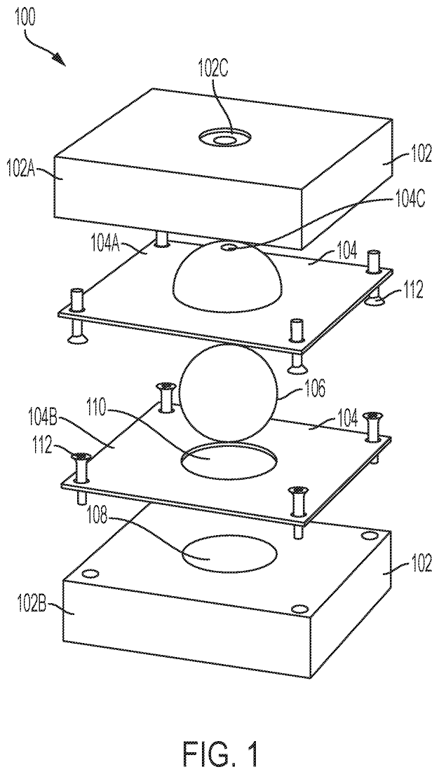

Turning to FIG. 1, an interchangeable mold 100 is shown according to an embodiment.

In this example, the interchangeable mold 100 includes a base mold 102 and a component mold 104. The base mold 102 includes a top base mold 102A and a bottom base mold 102B. The top base mold 102A and the bottom base mold 102B may define a base mold profile 108. The base mold profile 108 may be shaped according to the component 106 being formed by the interchangeable mold 100, or, as described herein, may be of any shape and configuration as to encompass a component profile 110 of the component mold 104.

The base mold 102 provides structural support for the component mold 104. The component mold 104 includes a top component mold sheet 104A and a bottom component mold sheet 104B that may be removably secured or removably affixed to the top base mold 102A and the bottom base mold 102B, respectively, of the base mold 102 using fasteners 112. The top component mold sheet 104A and the bottom component mold sheet 104B define the component profile 110 corresponding to the shape and configuration of the component 106 being formed by the interchangeable mold 100. While the component 106 being made with the interchangeable mold 100 is shown in FIG. 1 as a simple sphere for clarity purposes, it should be appreciated that the shape and configuration of the component 106 may be any shape and configuration of any complexity. The interchangeable mold 100 described herein may be used to manufacture any component conventionally manufactured using injection molding techniques.

As seen in this example, the component profile 110 includes a portion of a sphere defined within the top component mold sheet 104A and a corresponding remaining portion of a sphere defined within the bottom component mold sheet 104B. When the top component mold sheet 104A and the bottom component mold sheet 104B are mated together and the desired material of the component 106 is injected within the component mold 104 via openings 102C and 104C, the component 106 is created.

According to an embodiment, the base mold 102 may be created using additive manufacturing (e.g., 3D printing) and/or subtractive manufacturing with a polymer or nylon material. In such an embodiment, the component mold 104 may also be created using additive manufacturing (e.g., 3D printing), but using a metal material. Alternatively, the component mold 104 may be created using subtractive manufacturing (e.g., machining) using a metal material. Either or both of the base mold 102 and the component mold 104 may be further finished using additive and/or subtractive manufacturing processes. In such embodiments, a cost-effective material may be used to create the base mold 102, which may be a large percentage of the entire interchangeable mold 100, while a metal material may be used in sections of interchangeable mold 100 the formed material makes contact. The polymer or other material of the base mold 102 provides the structure and support for the component mold 104 without incurring the material degradation and heat damage that would be experienced with a traditional mold made entirely out of polymer or other non-metallic material. The metal of the component mold 104 provides heat resistance and durability while minimizing the quantity of metal used for the mold as compared to a traditional mold made entirely out of metal. The relatively thin metal sheet of the component mold 104 may be surface finished and/or modified via other manufacturing process to meet finishing requirements.

According to various embodiments, heat may be distributed away from the base mold 102 via heat dissipation channels, such as heat dissipation channels 102C and 104C, formed within the base mold 102 and the component mold 104, respectively, during additive manufacturing or by removing material using a subtractive manufacturing process. Heat may be allowed to naturally flow through such channels. Alternatively, heat dissipation using such channels may be facilitated by injecting or forcing air, other gasses, or cooling liquids through the channels. Note that heat dissipation channels 102C and 104C may also serve as openings through which material may be injected into component mold 104. Alternatively, the disclosed embodiments may have distinct and separate openings or channels for heat dissipation material injection. Note also that in some embodiments, there may be one or more heat dissipation channels in a base mold but not a component mold, allowing the heat emanating from the component mold to dissipate via the heat dissipation channel in the base mold. By building material voids, or heat dissipation channels, into the base mold 102, the component mold 104, and/or between the base mold 102 and the component mold 104, excess heat transferred from the injection molding material through the component mold 104 may be dissipated before the melting point of the base mold 102 is reached.

The base mold 102 has been described as being created using a polymer or nylon material, with the component mold being created from metal. The embodiments described herein are not limited to polymer or nylon materials in the base mold 102 and metal in the component mold 104. Rather, any suitable materials may be used in the base mold 102 and the component mold 104 without departing from the scope of this disclosure. For example, the base mold 102 may alternatively be created from metal or any other material. The metal for the base mold 102 could be the same as the metal used to create the component mold 104 or may be made from a different metal. If a metal is used for the base mold 102, the base mold 102 may be used for an indefinite period of time while various component molds 104 are coupled and uncoupled to the base mold 102 according to the component 106 being made, or as the component mold 104 wears or is otherwise exchanged or replaced for any reason.

The specific materials and dimensions of the base mold 102 and the component mold 104 may vary depending on the specific application and user preference. For example, for simple, non-complex components 106, stainless steel may be suitable for creating the component mold 104. For complex components 106 with fine details and texture, titanium or a hybrid of steel may be more desirable for the component mold 104 to provide the desired strength and other characteristics of the component 106. Similarly, the thickness of the component profile 110 of the component mold 104 may depend on the curvatures of the profile and the pressures exerted during manufacturing. A thickness of 2mm to 20mm may be adequate in many implementations; however, this disclosure is not limited to any particular thickness or thickness range.

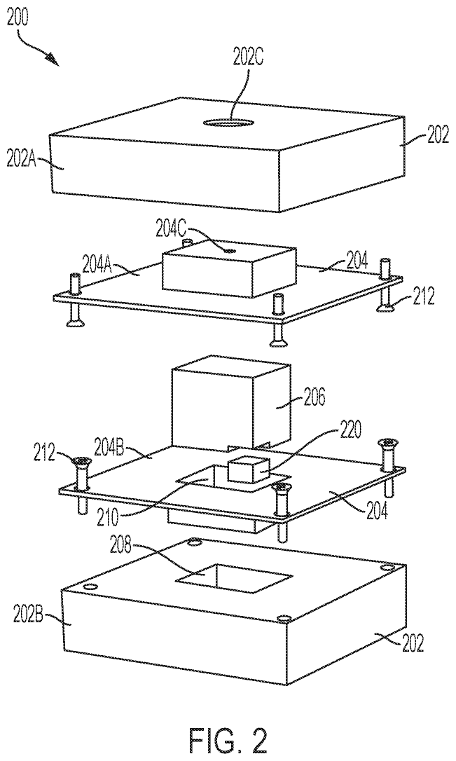

Turning to FIG. 2, an example of an interchangeable mold 200 will be described. According to this example, the component 206 being made with the interchangeable mold 200 has substantially planar sides. In this example, the base mold profile 208 and the component profile 210 are both substantially configured according to the corresponding shape and configuration of the component 206. In this example, the interchangeable mold 200 includes a base mold 202 and a component mold 204. The base mold 202 includes a top base mold 202A and a bottom base mold 202B. The top base mold 202A and the bottom base mold 202B may define the base mold profile 208. The base mold profile 208 may be shaped according to the component 206 being formed by the interchangeable mold 200 or, as described herein, may be of any shape and configuration as to encompass a component profile 210 of the component mold 204.

The base mold 202 provides structural support for the component mold 204. The component mold 204 includes a top component mold sheet 204A and a bottom component mold sheet 204B. Top component mold sheet 204A may be removably secured or removably affixed to the top base mold 202A using fasteners 212. Similarly, bottom component mold sheet 204B may be removably secured or removably affixed to bottom base mold 202B using fasteners 212. The top component mold sheet 204A and the bottom component mold sheet 204B define the component profile 210 corresponding to the shape and configuration of the component 206 being formed by the interchangeable mold 200. While the component 206 being made with the interchangeable mold 200 is shown in FIG. 2 as a simple cube for clarity purposes, it should be appreciated that the shape and configuration of the component 206 may be any shape and configuration of any complexity. The interchangeable mold 200 described herein may be used to manufacture any component conventionally manufactured using injection molding techniques.

As seen in this example, the component profile 210 includes a portion of a cube defined within the top component mold sheet 204A and a corresponding remaining portion of a cube defined within the bottom component mold sheet 204B. When the top component mold sheet 204A and the bottom component mold sheet 204B are mated together and the desired material of the component 206 is injected within the component mold 204 via openings 202C and 204C, the component 206 is created.

According to an embodiment, the base mold 202 may be created using additive manufacturing (e.g., 3D printing) with a polymer or nylon material or a combination of additive-subtractive manufacturing. In such an embodiment, the component mold 204 may also be created using additive manufacturing (e.g., 3D printing) and/or subtractive manufacturing, but using a metal material. Alternatively, the component mold 204 may be created using subtractive manufacturing (e.g., machining) using a metal material. Either or both of the base mold 202 and the component mold 204 may be further finished using additive and/or subtractive manufacturing processes. In such embodiments, a cost-effective material may be used to create the base mold 202, which may be a large percentage of the entire interchangeable mold 200, while a metal material may be used in sections of interchangeable mold 200 the formed material makes contact. The polymer or other material of the base mold 202 provides the structure and support for the component mold 204 without incurring the material degradation and heat damage that would be experienced with a traditional mold made entirely out of polymer or other non-metallic material. The metal of the component mold 204 provides heat resistance and durability while minimizing the quantity of metal used for the mold as compared to a traditional mold made entirely out of metal. The relatively thin metal sheet of the component mold 204 may be surface finished and/or modified via other manufacturing process to meet finishing requirements.

According to various embodiments, heat may be distributed away from the base mold 202 via heat dissipation channels, such as heat dissipation channels 202C and 204C, formed within the base mold 202 and the component mold 204, respectively, during additive manufacturing or by removing material using a subtractive manufacturing process. Heat may be allowed to naturally flow through such channels. Alternatively, heat dissipation using such channels may be facilitated by injecting or forcing air, other gasses, or cooling liquids through the channels. Note that heat dissipation channels 202C and 204C may also serve as openings through which material may be injected into component mold 204. Alternatively, the disclosed embodiments may have distinct and separate openings or channels for heat dissipation material injection. Note also that in some embodiments, there may be one or more heat dissipation channels in a base mold but not a component mold, allowing the heat emanating from the component mold to dissipate via the heat dissipation channel in the base mold. By building material voids, or heat dissipation channels, into the base mold 202, the component mold 204, and/or between the base mold 202 and the component mold 204, excess heat transferred from the injection molding material through the component mold 204 may be dissipated before the melting point of the base mold 202 is reached.

According to various embodiments, one or more inserts may be used with the disclosed interchangeable molds. For example, insert 220 may be configured in component mold 204 to allow even greater flexibility in forming the shape of component 206. Inserts such as insert 220 may be used in a component mold, a base mold, or both. Inserts such as 220 may also be configured to be attached to a base mold and protrude through a component mold to impact the formation of a component. In various embodiments, there may be recesses, openings, slots, indentations, insertion points, grooves, etc., that may be formed in a component mold and/or a base mold to accommodate inserts.

The base mold 202 has been described as being created using a polymer or nylon material, with the component mold being created from metal. The embodiments described herein are not limited to polymer or nylon materials in the base mold 202 and metal in the component mold 204. Rather, any suitable materials may be used in the base mold 202 and the component mold 204 without departing from the scope of this disclosure. For example, the base mold 202 may alternatively be created from metal or any other material. The metal for the base mold 202 could be the same as the metal used to create the component mold 204 or may be made from a different metal. If a metal is used for the base mold 202, the base mold 202 may be used for an extended period of time while various component molds 204 are coupled and uncoupled to the base mold 202 according to the component 206 being made, or as the component mold 204 wears or is otherwise exchanged or replaced for any reason.

The specific materials and dimensions of the base mold 202 and the component mold 204 may vary depending on the specific application and user preference. For example, for simple, non-complex components 206, stainless steel may be suitable for creating the component mold 204. For complex components 206 with fine details and texture, titanium or a hybrid of steel may be more desirable for the component mold 204 to provide the desired strength and other characteristics of the component 206. Similarly, the thickness of the component profile 210 of the component mold 204 may depend on the curvatures of the profile and the pressures exerted during manufacturing. A thickness of 2mm to 20mm may be adequate in many implementations; however, this disclosure is not limited to any particular thickness or thickness range.

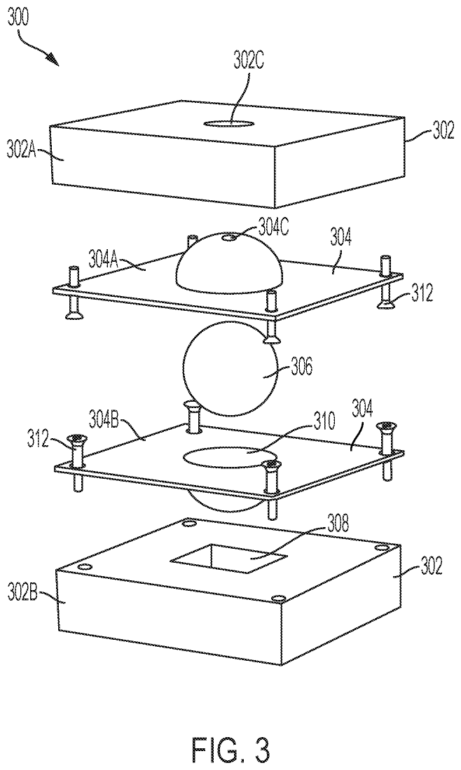

The interchangeable molds of the disclosed embodiments provide great versatility by allowing use of a base mold and a component mold. Referring now to FIG. 3 and interchangeable mold 300, a base mold 302 that includes a top base mold 302A and a bottom base mold 302B defines a base mold profile 308 that has substantially planar sides. However, the component profile 310 of the component mold 304 is substantially spherical to create a sphere, or component 306. The component profile 310 of the component mold 304 fits within the base mold profile 308 of the base mold 302. Although the base mold profile 308 and the component profile 310 are not identical, the two profiles are sized to fit within one another.

The example shown in FIG. 3 illustrates how a base mold 302 may be installed in a production line and used to create numerous and various components 306. When switching between the production of two different components, the applicable component mold 304 is exchanged via fasteners 312, without requiring removal and replacement of the base mold 302, as long as the component profile 310 of the applicable component mold 304 rests within the base mold profile 308 of the installed base mold 302.

Because the component molds 304 are relatively thin compared to traditional molds used in injection molding production lines, the required storage space for storing molds is significantly reduced using the embodiments described herein, as only a limited number of the larger base molds 302 are used and stored, while the numerous component molds 304 maybe relatively thin, lightweight, and easy to move. Similarly, changeover of the molds on the production line may be simplified using the embodiments described herein as compared to traditional methods since changeover requires only removing fasteners 312 and replacing the reduced weight component molds 304.

The base mold 302 provides structural support for the component mold 304. The component mold 304 includes a top component mold sheet 304A and a bottom component mold sheet 304B. Top component mold sheet 304A may be removably secured or removably affixed to the top base mold 302A using fasteners 312. Similarly, bottom component mold sheet 304B may be removably secured or removably affixed to bottom base mold 302B using fasteners 312. The top component mold sheet 304A and the bottom component mold sheet 304B define the component profile 310 corresponding to the shape and configuration of the component 306 being formed by the interchangeable mold 300. While the component 306 being made with the interchangeable mold 300 is shown in FIG. 3 as a simple sphere for clarity purposes, it should be appreciated that the shape and configuration of the component 306 may be any shape and configuration of any complexity. The interchangeable mold 300 described herein may be used to manufacture any component conventionally manufactured using injection molding techniques.

As seen in this example, the component profile 310 includes a portion of a sphere defined within the top component mold sheet 304A and a corresponding remaining portion of a sphere defined within the bottom component mold sheet 304B. When the top component mold sheet 304A and the bottom component mold sheet 304B are mated together and the desired material of the component 306 is injected within the component mold 304 via openings 302C and 304C, the component 306 is created. As noted, the component profile 310 of the component mold 304 is substantially spherical to create a sphere, or component 306. The component profile 310 of the component mold 304 fits within the base mold profile 308 of the base mold 302, even though the base mold profile 308 and the component profile 310 are not identical, and indeed may be very different. As shown in the figure, the two profiles may be sized to fit within one another.

According to an embodiment, the base mold 302 may be created using additive manufacturing (e.g., 3D printing) with a polymer or nylon material. In such an embodiment, the component mold 304 may also be created using additive manufacturing (e.g., 3D printing), but using a metal material. Alternatively, the component mold 304 may be created using subtractive manufacturing (e.g., machining) using a metal material. Either or both of the base mold 302 and the component mold 304 may be further finished using additive and/or subtractive manufacturing processes. In such embodiments, a cost-effective material may be used to create the base mold 302, which may be a large percentage of the entire interchangeable mold 300, while a metal material may be used in sections of interchangeable mold 300 the formed material makes contact. The polymer or other material of the base mold 302 provides the structure and support for the component mold 304 without incurring the material degradation and heat damage that would be experienced with a traditional mold made entirely out of polymer or other non-metallic material. The metal of the component mold 304 provides heat resistance and durability while minimizing the quantity of metal used for the mold as compared to a traditional mold made entirely out of metal. The relatively thin metal sheet of the component mold 304 may be surface finished and/or modified via other manufacturing process to meet finishing requirements.

According to various embodiments, heat may be distributed away from the base mold 302 via heat dissipation channels, such as heat dissipation channels 302C and 304C, formed within the base mold 302 and the component mold 304, respectively, during additive manufacturing or by removing material using a subtractive manufacturing process. Heat may be allowed to naturally flow through such channels. Alternatively, heat dissipation using such channels may be facilitated by injecting or forcing air, other gasses, or cooling liquids through the channels. Note that heat dissipation channels 302C and 304C may also serve as openings through which material may be injected into component mold 304. Alternatively, the disclosed embodiments may have distinct and separate openings or channels for heat dissipation material injection. Note also that in some embodiments, there may be one or more heat dissipation channels in a base mold but not a component mold, allowing the heat emanating from the component mold to dissipate via the heat dissipation channel in the base mold. By building material voids, or heat dissipation channels, into the base mold 302, the component mold 304, and/or between the base mold 302 and the component mold 304, excess heat transferred from the injection molding material through the component mold 304 may be dissipated before the melting point of the base mold 302 is reached.

The base mold 302 has been described as being created using a polymer or nylon material, with the component mold being created from metal. The embodiments described herein are not limited to polymer or nylon materials in the base mold 302 and metal in the component mold 304. Rather, any suitable materials may be used in the base mold 302 and the component mold 304 without departing from the scope of this disclosure. For example, the base mold 302 may alternatively be created from metal or any other material. The metal for the base mold 302 could be the same as the metal used to create the component mold 304 or may be made from a different metal. If a metal is used for the base mold 302, the base mold 302 may be used for an extended period of time while various component molds 304 are coupled and uncoupled to the base mold 302 according to the component 306 being made, or as the component mold 304 wears or is otherwise exchanged or replaced for any reason.

The specific materials and dimensions of the base mold 302 and the component mold 304 may vary depending on the specific application and user preference. For example, for simple, non-complex components 306, stainless steel may be suitable for creating the component mold 304. For complex components 306 with fine details and texture, titanium or a hybrid of steel may be more desirable for the component mold 304 to provide the desired strength and other characteristics of the component 306. Similarly, the thickness of the component profile 310 of the component mold 304 may depend on the curvatures of the profile and the pressures exerted during manufacturing. A thickness of 2mm to 20mm may be adequate in many implementations; however, this disclosure is not limited to any particular thickness or thickness range.

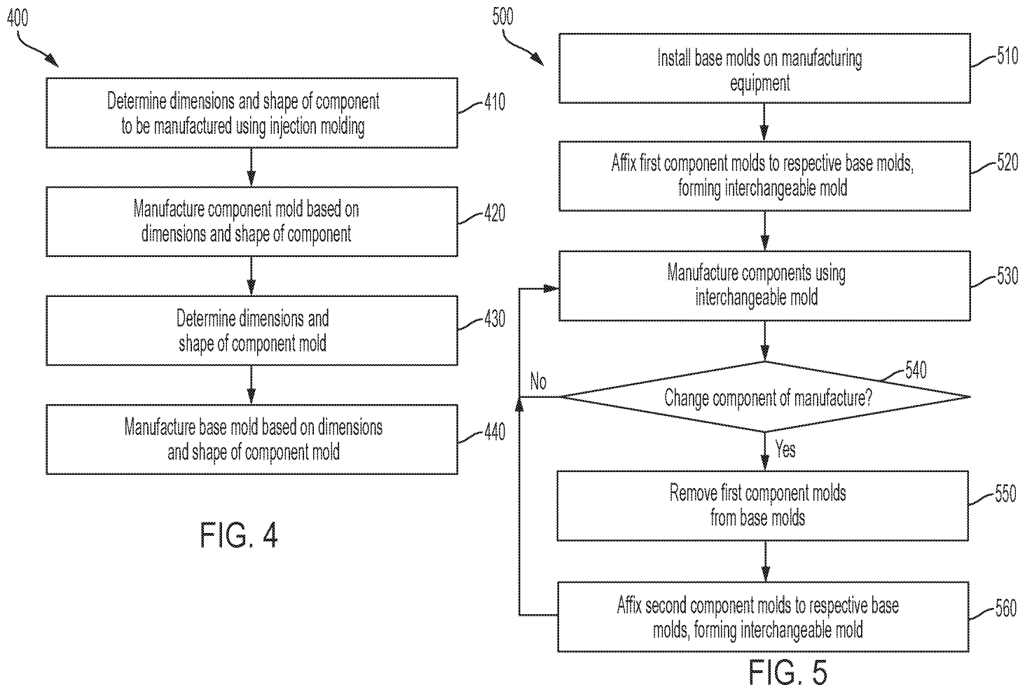

FIG. 4 shows a block diagram illustrating a method 400 of manufacture of an interchangeable mold according to an embodiment. Note that, in various embodiments, any one or more of the operations described in reference to FIG. 4 may be performed in any order and in any combination with any other operations. At operation 410, the dimensions and shape of a component to be manufactured using injection molding are determined. In various embodiments, the dimensions and shapes of any inserts that may be used with a component mold may also be determined. Using these dimensions and shapes, at operation 420 a component mold may be manufactured out of any material using any additive manufacturing process, subtractive manufacturing process, or any combination thereof. In an embodiment, the component mold may be manufactured out of a metal material using 3D printing or other additive manufacturing processes. A final desired shape and dimensions of the component mold may also be taken into account at operation 420, for example, based on a desired final base mold dimensions and shape or on a final assembled interchangeable mold dimensions and shape so that the interchangeable mold fits in a particular manufacturing facility or machine.

At operation 430, the dimensions and shape of the component mold may be determined. In various embodiments, the dimensions and shapes of any inserts that may be used with a base mold may also be determined. Using these dimensions and shapes, at operation 440 a base mold may be manufactured out of any material using any additive manufacturing process, subtractive manufacturing process, or any combination thereof. In an embodiment, the base mold may be manufactured out of a polymer material using 3D printing or other additive manufacturing processes. A final desired shape and dimensions of the base mold may also be taken into account at operation 440, for example, based on a desired final base mold dimensions and shape or on a final assembled interchangeable mold dimensions and shape so that the interchangeable mold fits in a particular manufacturing facility or machine.

In various embodiments, the shape and configuration of a base mold may be manufactured to be complimentary to the shape and configuration of more than one component mold, thus enabling a single base bold to accommodate multiple components molds, facilitating the exchange of component molds without requiring a change of the base mold. For example, a base mold may be configured with one or more voids or spaces that accommodate component molds that may have a variety of shapes and configurations.

In various embodiments, the shape and configuration of a component mold may be manufactured to accommodate one or more inserts that may also help form the shape and configuration of an injection molded component. In addition, or instead, a shape and configuration of a base mold may be manufactured to accommodate one or more inserts that may also help form the shape and configuration of an injection molded component. In various embodiments, a shape and configuration of a component mold may compliment a shape and configuration of a base mold such that the shape and configuration of the combination of the base mold and the component mold accommodate one or more inserts that may help form the shape and configuration of an injection molded component.

FIG. 5 shows a block diagram illustrating a method 500 of use of an interchangeable mold according to an embodiment. Note that, in various embodiments, any one or more of the operations described in reference to FIG. 5 may be performed in any order and in any combination with any other operations. At operation 510, a base mold of an interchangeable mold may be installed on manufacturing equipment. At operation 520, component mold may be affixed to the base mold to assemble the interchangeable mold. Also at this operation, in some embodiments, inserts may be installed on the base mold and/or the component mold. At operation 530, the manufacture of injection molded components may commence using the assembled interchangeable mold.

As described herein, various component molds may be used with a same base mold of an interchangeable mold. At operation 540, a determination may be made as to whether a different component is to be manufactured, and hence a different component mold needed. If not, manufacturing may proceed using the installed component mold at operation 530. Note that the determination at 540 may also, or instead, include a determination of whether the component mold is worn, damaged, or otherwise needs to be replace for any reason.

If, at operation 540, it is determined that the component mold should be changed to, for example, accommodate manufacture of a different component or due to wear, at operation 550 the component mold may be removed from the base bold of an interchangeable mold. At operation 560, a different component mold may be installed with the previously installed base mold to assemble a complete interchangeable mold. The process may return to operation 530 to commence manufacturing using the updated interchangeable mold. Due to the ease of swapping the component mold portion of an interchangeable mold provided by the disclosed embodiments, transitions between manufacture of various components can be made more efficient.

Many modifications and other embodiments of the disclosure will come to mind to one skilled in the art to which this disclosure pertains having the benefit of the teachings presented in the foregoing descriptions and the associated drawings. For example, as will be understood by one skilled in the relevant field in light of this disclosure, the embodiments may take form in a variety of different mechanical and operational configurations. Therefore, it is to be understood that the disclosure is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

What is claimed is:

1. An interchangeable mold for creation of injection molded components, the interchangeable mold comprising:
a component mold comprising:
a top portion of the component mold, and
a bottom portion of the component mold, the top portion of the component mold and the bottom portion of the component mold defining a component profile; and
a base mold comprising:
a top portion of the base mold, the top portion of the base mold accommodating a profile of the top portion of the component mold, and
a bottom portion of the base mold, the bottom portion of the base mold accommodating a profile of the bottom portion of the component mold,
wherein the top portion of the component mold is configured to detachably affix to the top portion of the base mold, and
wherein the bottom portion of the component mold is configured to detachably affix to the bottom portion of the base mold.

2. The interchangeable mold of claim 1, wherein the base mold comprises a polymer material, and wherein the component mold comprises a metal material.

3. The interchangeable mold of claim 2, wherein the base mold is created using an additive manufacturing process or an additive-subtractive manufacturing process.

4. The interchangeable mold of claim 2, wherein the component mold is created using an additive manufacturing process or an additive-subtractive manufacturing process.

5. The interchangeable mold of claim 2, wherein the component mold is created using subtractive manufacturing process.

6. The interchangeable mold of claim 1, wherein the base mold comprises at least one heat dissipation channel.

7. The interchangeable mold of claim 1, wherein the component mold comprises at least one recess to accommodate an insert.

8. The interchangeable mold of claim 1, further comprising:
a second component mold comprising:
a top portion of the second component mold, and
a bottom portion of the second component mold, the top portion of the second component mold and the bottom portion of the second component mold defining a second component profile,
wherein the top portion of the base mold accommodates a profile of the top portion of the second component mold, and
wherein the bottom portion of the base mold accommodates a profile of the bottom portion of the second component mold.

9. A method of manufacturing an interchangeable mold, the method comprising:
manufacturing a top portion of a component mold and a bottom portion of the component mold,
wherein the top portion of the component mold and the bottom portion of the component mold define a profile of a component; and
manufacturing a top portion of a base mold and a bottom portion of a base mold,
wherein the top portion of the base mold accommodates a profile of the top portion of the component mold,
wherein the top portion of the component mold is manufactured to be detachably affixed to the top portion of the base mold,
wherein the bottom portion of the base mold accommodates a profile of the bottom portion of the component mold, and
wherein the bottom portion of the component mold is manufactured to be detachably affixed to the bottom portion of the base mold.

10. The method of claim 9, wherein manufacturing the top portion of the base mold and the bottom portion of the base mold comprises manufacturing the top portion of a component mold and the bottom portion of the component mold using an additive manufacturing process.

11. The method of claim 10, wherein using the additive manufacturing process comprises 3D printing the top portion of the base mold and the bottom portion of the base mold using a polymer material and refining the top portion of the base mold or the bottom portion of the base mold via an additive-subtractive manufacturing process.

12. The method of claim 9, wherein manufacturing the top portion of the component mold and the bottom portion of the component mold comprises manufacturing the top portion of a component mold and the bottom portion of the component mold using an additive-subtractive manufacturing process.

13. The method of claim 12, wherein using the additive manufacturing process comprises 3D printing the top portion of the component mold and the bottom portion of the component mold using a metal material.

14. The method of claim 9, wherein manufacturing the top portion of the component mold and the bottom portion of the component mold comprises manufacturing the top portion of a component mold and the bottom portion of the component mold using a subtractive manufacturing process.

15. The method of claim 14, wherein using the subtractive manufacturing process comprises machining the top portion of the component mold and the bottom portion of the component mold using a metal material.

16. The method of claim 9, wherein manufacturing the top portion of the base mold comprises forming a heat dissipation channel in the top portion of the base mold.

17. The method of claim 9, wherein manufacturing the top portion of the component mold and the bottom portion of the component mold comprises forming a recess to accommodate an insert in at least one of the top portion of the component mold or the bottom portion of the component mold.

18. The method of claim 9, wherein the top portion of the base mold accommodating the profile of the top portion of the component mold comprises the top portion of the base mold defining the profile of the top portion of the component mold, and
wherein the bottom portion of the base mold accommodating the profile of the bottom portion of the component mold comprises the bottom portion of the base mold defining the profile of the bottom portion of the component mold

19. A method of manufacturing an injection molded component, the method comprising:
detachably affixing a top portion of a component mold to a top portion of a base mold,
wherein the top portion of the component mold defines a top portion of a profile of the injection molded component, and
wherein the top portion of the base mold accommodates the top portion of the component mold;
detachably affixing a bottom portion of the component mold to a bottom portion of the base mold,
wherein the bottom portion of the component mold defines a bottom portion of the profile of the injection molded component, and
wherein the bottom portion of the base mold accommodates the bottom portion of the component mold;
assembling the top portion of the component mold, the top portion of the base mold, the bottom portion of the component mold, and the bottom portion of the base mold into an injection mold; and
injecting material into the injection mold to form the injection molded component.

20. The method of claim 19, further comprising:
disassembling the injection mold;
detaching the top portion of the component mold from the top portion of the base mold;
detaching the bottom portion of the component mold from the bottom portion of the base mold;
detachably affixing a top portion of a second component mold to the top portion of the base mold,
detachably affixing a bottom portion of the second component mold to the bottom portion of the base mold,
assembling the top portion of the second component mold, the top portion of the base mold, the bottom portion of the second component mold, and the bottom portion of the base mold into a second injection mold; and
injecting material into the second injection mold to form a second injection molded component.
